(19) United States
(12) Patent Application Publication
(10) Pub. No.: US 2009/0287247 A1
(43) Pub. Date: Nov. 19, 2009

(54) Teething, Imbibing, and Entertainment Apparatus and Methods

(76) Inventors: Rita Carrie Ann Chipperson, Florham Park, NJ (US); David Alan Chipperson, Florham Park, NJ (US)

Correspondence Address: Law Offices of Rita C. Chipperson, P.C., 55 Madison Ave, Suite 400, Morristown, NJ, 07960, US

(21) Appl. No.: 12/467,283

(22) Filed: May 17, 2009

Related U.S. Application Data
(60) Provisional application No. 61/054,148, filed on May 18, 2008.

(51) Int. Cl. A61J 17/02

(52) U.S. Cl. 606/235

(57) ABSTRACT

Teething, imbibing, and entertainment apparatus and methods utilizing fluids, wherein such fluids may be room temperature, warmed, chilled, frozen, and/or partially-frozen. A fillable body allows a user to imbibe warmed, chilled, frozen, and/or partially-frozen fluids through one or more apertures. A plurality of chewable exterior features, protrusions, and nipples further aid in easing teething pain and/or entertainment. A detachable nipple allows the apparatus to be used with a variety of nipples having differing configurations and sizes. The handles facilitate holding of the apparatus by young users with limited motor skills such as infants and toddlers. The methods allow a child to chew on frozen liquids to at least partially thaw such liquids such that the chilled liquid and/or slush may be directed to the user's gums, teeth, mouth, and/or throat via aperture(s). Similarly, methods of directing a heated liquid to a child's gums, teeth, mouth, and/or throat are also disclosed.

### CROSS-REFERENCE TO RELATED APPLICATIONS

This application claims the benefit of the U.S. provisional patent application entitled “Teething, Imbibing, and Entertainment Apparatus and Methods”, having Ser. No. 61/054,148, filed May 18, 2008, which is hereby incorporated by reference in its entirety as if fully set forth herein.

### BACKGROUND OF THE INVENTION

Embodiments of the present invention generally relate to teething, imbibing, and entertainment apparatus and methods. More specifically, the present invention relates to teething, imbibing, and entertainment apparatus and methods for infants and children utilizing fluids, wherein such fluids may be room temperature, warmed, chilled, frozen, and/or partially-frozen fluids.

It is known to use freezable liquid filled devices for the purpose of soothing teething pain. Such devices typically include a sealed reservoir in which a freezable liquid is located. A user may chew on the device and the frozen liquid to apply a cold surface to the gums. Once the liquid melts, the device is typically washed and placed into a freezer to allow the contained liquid to be re-frozen for future use.

### BRIEF SUMMARY OF THE INVENTION

Briefly stated, in one aspect of the present invention, a method of soothing teething is provided. This method includes: filling an apparatus with a fluid; altering a temperature of the fluid contained in the apparatus; and imbibing the fluid through the nipple of the apparatus. This apparatus includes: a nipple including at least one nipple cavity; and a shaft, the shaft including at least one shaft cavity, the shaft cavity in fluid communication with the nipple cavity.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1A is a perspective view of a teething, imbibing, and entertainment apparatus in accordance with one embodiment of the present invention;

FIG. 1B is an exploded view of the attachment of a nipple to the teething, imbibing, and entertainment apparatus of FIG. 1A;

FIG. 2 is a top view of the teething, imbibing, and entertainment apparatus of FIG. 1A;

FIG. 3 is a bottom view of the teething, imbibing, and entertainment apparatus of FIG. 1A;

FIG. 4 is a cross-sectional view of the nipple of the teething, imbibing, and entertainment apparatus of FIG. 1A taken along lines 4-4 of FIG. 3;

FIG. 5 is a cross-sectional side view of the nipple of the teething, imbibing, and entertainment apparatus of FIG. 1A taken along lines 5-5 of FIG. 3;

FIG. 6 is a cross-sectional view of the teething, imbibing, and entertainment apparatus of FIG. 1A taken along lines 6-6 of FIG. 3;

FIG. 7A is a cross-sectional view of the teething, imbibing, and entertainment apparatus of FIG. 1A taken along lines 7A-7A of FIG. 4;

FIG. 7B is a cross-sectional view of the teething, imbibing, and entertainment apparatus of FIG. 1A taken along lines 7B-7B of FIG. 4;

FIG. 8 is a magnified view of one embodiment of a coupling mechanism for coupling a nipple to the teething, imbibing, and entertainment apparatus of FIG. 1A; and

FIG. 9 is a cross-sectional view of the shaft extension of the teething, imbibing, and entertainment apparatus of FIG. 1A.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a handle” includes a plurality of handles. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described.

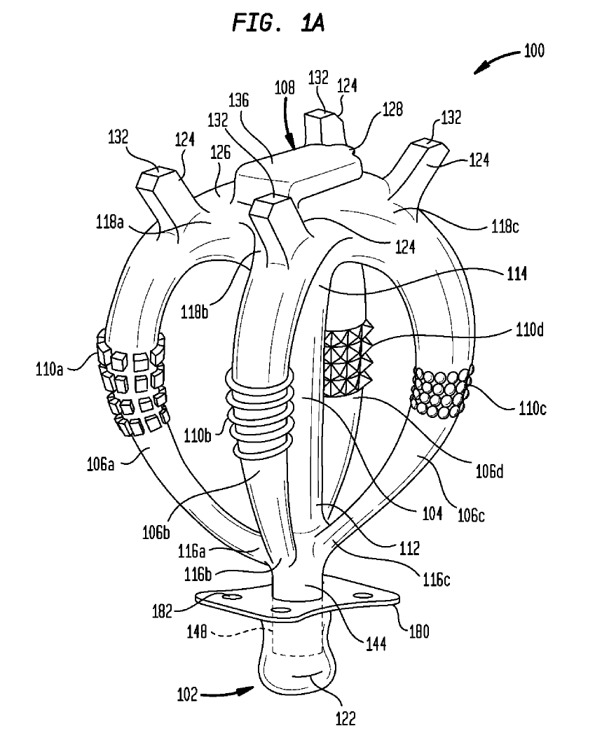

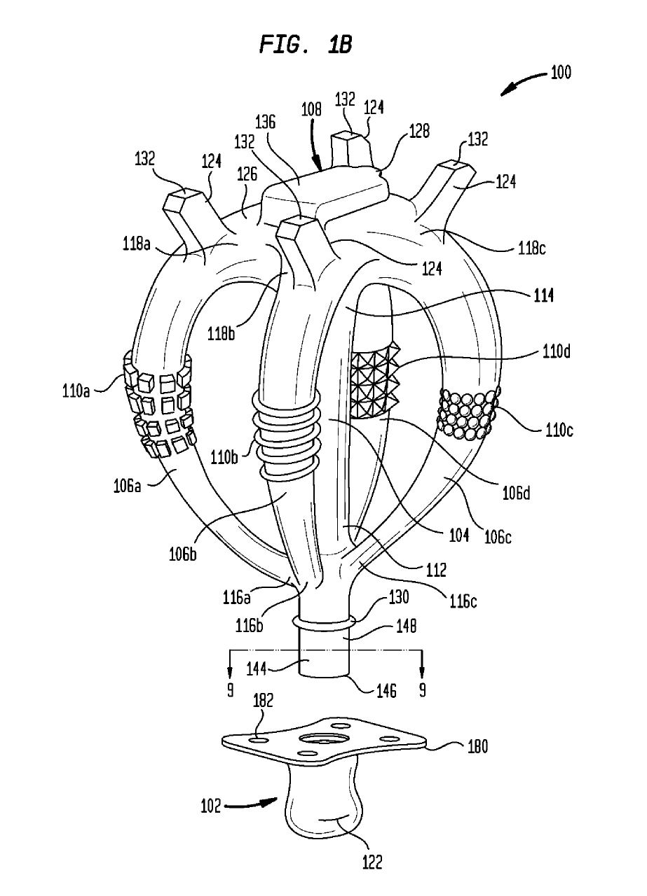

Referring first to FIG. 1A, depicted is a teething, imbibing, and entertainment apparatus in accordance with one embodiment of the present invention (hereinafter referred to as the teething apparatus 100). In the depicted embodiment, the teething apparatus 100 includes, inter alia, a nipple 102, a shaft 104, handles 106, a cap 108, and supports 124.

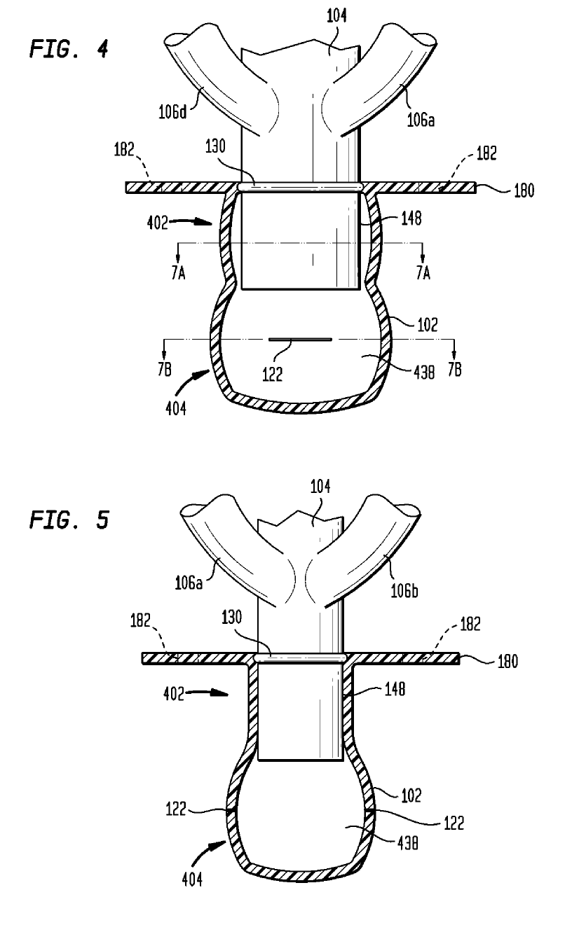

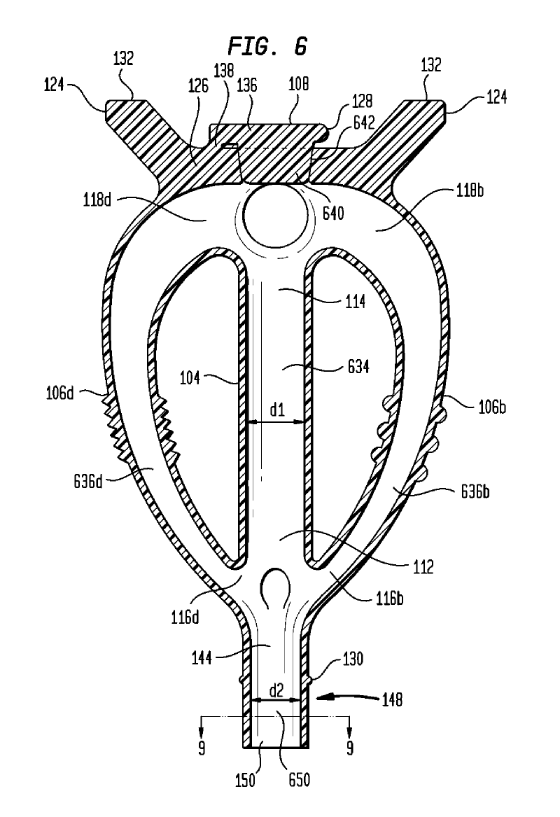

The shaft 104 and handles 106 include shaft and handle cavities 634 and 636, respectively, as depicted in FIG. 6, in which a fluid, or a frozen fluid, may rest or flow therethrough. The shaft and/or handle cavities 634 (FIG. 6) and 636 (FIG. 6), respectively, are in communication with a nipple cavity 438 (FIGS. 4 and 5), which allows the fluid to flow freely from the shaft and/or handle cavities 634 (FIG. 6) and 636 (FIG. 6), respectively, to the nipple cavity 438 (FIGS. 4 and 5). From the nipple cavity 438 (FIGS. 4 and 5), fluid may flow through one or more apertures 122 to the exterior of the nipple 102. This fluid communication allows a person (e.g., an infant or child) to imbibe a liquid or other fluid contained within the teething apparatus 100 via the nipple 102. Such fluid may be room temperature, warmed, chilled, partially-frozen, or fully-frozen. The temperature of the fluid may be altered (e.g., heated, cooled, frozen, etc.) either prior or subsequent to filling of the teething apparatus 100 as further described herein.

In one aspect of the depicted embodiment of the present invention, the teething apparatus 100 may be filled with a fluid via bore 640 (FIG. 6) located in the support base 126. In the depicted embodiment of the present invention, the bore 642 is a tapered, substantially cylindrical bore passing completely through the support base 126. The inwardly facing surfaces (i.e., the surfaces facing the axis of the teething apparatus 100) taper slightly inward from a first diameter to a second diameter as the bore 642 progresses from an exterior surface of the support base 126 to an interior surface thereof. The bore 642 is designed to mate with a cap 108, which includes a first cap portion 136 and a second cap portion 640, to form a substantially watertight seal.

More specifically, the outwardly facing surfaces (i.e., the surfaces facing away from the axis of the teething apparatus 100) of the second cap portion 640 are substantially cylindrical and are tapered slightly inward as they progress from an exterior surface of the support base 126 to an interior surface thereof. The similarly tapered inwardly facing surfaces of the bore 642 and outwardly facing surfaces of the second cap portion 640 seal the bore 642 in a substantially watertight manner when the second cap portion 640 is inserted therein and open the bore 642 when the second cap portion 640 is removed therefrom. This allows the teething apparatus 100 to be filled with a fluid by removing the cap 108 from the bore 642, pouring a fluid into the teething apparatus 100 through the bore 642, and replacing the cap 108 such that a substantially watertight seal is formed.

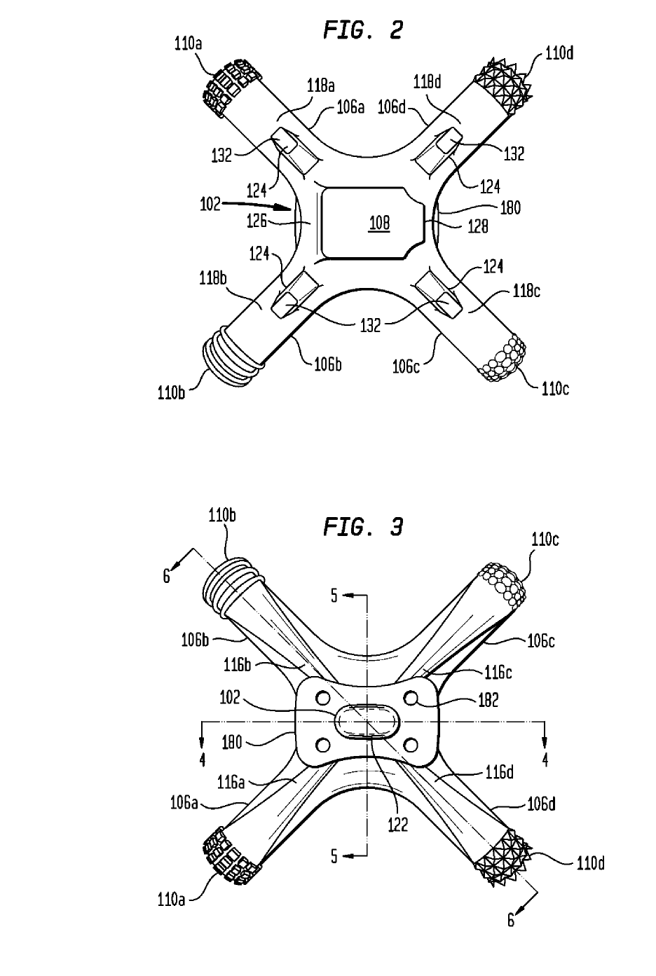

As better seen in FIG. 2, cap 108 also includes a substantially rectangular first cap portion 136. A proximal end of the first cap portion 136 is affixed to an external surface of the support base 126 in order to irremovably attach the cap 108 to the teething apparatus 100. Tethering of the cap 108 to the support base 126 may be achieved by molding cap 108 at the same time that support base 126 and any other components coupled thereto are molded such that support base 126, any other components molded thereto, and cap 108 are one piece. In one aspect of the present invention, this attachment of cap 108 to support base 126 prevents or minimizes the potential of an injury to an infant or child caused by swallowing of or choking on the cap 108 when it is removed from the bore 642. That is, the likelihood of the swallowing of or choking on the cap 108 is minimized, since an infant or child cannot place the cap 108 and the remainder of the attached teething apparatus 100 into his or her mouth due to the size of such remainder. Alternatively, any other suitable means including, but not limited to, a flexible, linear attachment or a hinge may couple the cap 108 to the support base 126 without departing from the scope of the present invention.

Furthermore, in the depicted embodiment of the present invention, the distal end of the cap 108 includes a tab 128 to facilitate opening and closing of the bore 642 via the insertion and removal of the cap 108. The tab 128 is in the form of a small flap that extends beyond the edge of the first cap portion 136 to an extent that allows enough material for a user of the teething apparatus 100 to easily grasp such tab 128. This grasping allows the user to more easily remove and/or the insert cap 108 into the bore 642. Although one form of the cap 108 is described herein with specificity, virtually any other type of cap or similar mechanism for opening and closing a bore or port such as the bore 642 may be substituted without departing from the scope of the present invention, without affecting the utility of the present invention.

Although cap 108 and bore 640 are described herein with specificity, alternate apparatus (other than cap 108 and bore 640) for allowing teething apparatus 100 to be filled and unfilled may be substituted without departing from the scope of the present invention.

The filled teething apparatus 100 may then be used with the contained liquid at its present temperature, or, alternatively, the filled teething apparatus 100 may be placed in a refrigerator or freezer to partially or completely cool or freeze the liquid prior to use. Or, the filled teething apparatus 100 may be placed in a microwave or other heating device to raise the temperature of the contained liquid. Once the contained liquid is brought to the desired temperature, a non-frozen liquid may be sucked, or otherwise imbibed, by the user through apertures 122 of nipple 102 for a variety of purposes. For example, when used by an infant or child, a chilled liquid may act to soothe teething pain. As another example, a heated liquid may act to soothe pain associated with a sore throat or other malady particularly when the heated liquid includes one or more soothing ingredients such as, but not limited to, honey. In yet another example, a child may just enjoy imbibing a liquid via teething apparatus as an alternative to imbibing such liquids via a more traditional children's cup (e.g., a sippy cup) regardless of whether the child is teething or sick. A child may prefer to imbibe liquid from teething apparatus 100 for a variety of reasons including, but not limited to, ease of use, ease of holding handles 106, and the aesthetics of exterior features 110.

When teething apparatus 100 is filled with a fully frozen liquid, a user obviously cannot suck, or otherwise imbibe, the frozen liquid through apertures 122 of nipple 102. Teething apparatus 100 is designed for such use in that the child may bite or chew on the exterior of teething apparatus 100, which also acts to soothe teething pain. As the teething apparatus 100 is bitten or chewed, and/or held by the user, and/or maintained in an ambient temperature, the frozen liquid will slowly melt such that a slow, controlled supply of slushy liquid is formed. The child may imbibe this slushy liquid through apertures 122 of nipple 102 as it is formed to further soothe teething and/or for enjoyment purposes.

The type of liquid use in conjunction with teething apparatus 100 may also enhance the enjoyment of using teething apparatus 100. For example, a child user of teething apparatus 100 is more likely to enjoy such use when the contained liquid is a sugary liquid such as juice, chocolate milk, or the like. However, teething apparatus 100 may also be used with plain water or any other liquid without departing from the scope of the present invention.

The support base 126 includes a plurality of supports 124 protruding outwardly therefrom and surrounding the bore 642 and the cap 108 therein. In the present embodiment of FIG. 1, the support base 126 includes four supports 124, each approximately in register with one of the handles 106, and positioned in a substantially rectangular configuration. The distal end of each support 124 includes a substantially flat support end 132, opposite the support base 126, that extends beyond the plane of the cap 108 when such cap is fitted within the bore 642. Thus, the teething apparatus 100 can be oriented with the nipple 102 extending upwardly, with the supports 124 and the substantially flat support ends 132 functioning as a foundation, which rest on a horizontal support surface. The inverted orientation of the teething apparatus 100 with the nipple 102 oriented upwardly, is useful when cooling or freezing a liquid contained within the teething apparatus 100. The inverted orientation requires minimal space within a refrigerator or freezer, and minimizes leakage of liquid from the nipple 102 that might occur in other orientations of the teething apparatus 100. Additionally, the supports 124 also function as an easily accessible, rough feature for the young child to use for teething. However, alternate embodiments of supports 124 and/or support ends 132 may be omitted and/or substituted without departing from the scope of the present invention. For example, support ends 132 may be located in a common plane with the cap 108, when such cap is fitted within the bore 642, such that the cap 108 also contacts the support surface. This alternative embodiment provides additional stability for the teething apparatus 100 when oriented with the nipple 102 extending upwardly. Or, in yet another example, supports 124 and support ends 132 are omitted. In this example, the teething apparatus 100 may be positioned with the nipple oriented horizontally, upwardly, or downwardly during cooling, heating, or freezing without departing from the scope of the present invention. In still another example, a support surface may be formed integral to one or more handles 106 such that teething apparatus may be easily rested upon a side without departing from the scope hereof.

The teething apparatus 100 also includes a central shaft 104. In the embodiment of the present invention depicted in FIG. 1A, the shaft 104 is substantially cylindrical and has an ovate cross section, the latter of which is substantially identical to the cross section of the shaft extension 148 (FIG. 9). However, alternate embodiments of the present invention are envisioned in which the cross-sectional dimensions of the shaft 104 and the shaft extension 148 vary.

Shaft 104 also includes a hollow interior in the form of a shaft cavity 634, as depicted in the cross-sectional view of FIG. 6, which is also substantially cylindrical with an ovate cross section. The shaft 104 has a uniform inner diameter d₁ that is approximately equal to the uniform inner diameter d₂ of shaft extension 148. The shaft 104 also includes a first shaft end 112 and a second shaft end 114.

The first shaft end 112 is coupled to, inter alia, the proximal end 144 of the shaft extension 148. In some embodiments of the present invention, the shaft extension 148 is also substantially cylindrical with an ovate cross section as depicted in the cross-section view of FIG. 9. The shaft extension 148 includes a hollow interior in the form of a shaft extension cavity 650 as depicted in the cross-sectional view of FIG. 6. The uniform inner diameter d₂ of shaft extension 148 is approximately equivalent to the uniform inner diameter d₁ of shaft 104. This uniformity of the interior dimension of shaft 104 and shaft extension 148 has a plurality of benefits including, but not limited to, ease of transfer of a partially frozen fluid from the shaft 104 to shaft extension 148 to the nipple 102 via shaft extension aperture 146. That is, the uniformity of the interior dimensions provides a smooth, continuous inwardly facing surface of the shaft 104 and the shaft extension 148 along which a cleaning mechanism (e.g., a bottle brush, a rag, etc.) or a frozen or partially-frozen fluid may easily slide without obstruction. The material from which teething apparatus 100 is fabricated further facilitates such sliding as discussed in further detail below.

In some embodiments of the present invention, the first shaft end 112 is also coupled to one or more first handle ends 116. In the depicted embodiment of the present invention, there are four first handle ends 116 connected to the first shaft end 112 at the approximate 0, 90, 180 and 270 degree positions in relation to the axis of the shaft 104 near the first shaft end 112 as most easily seen in the top and bottom views of FIGS. 2 and 3, respectively. First handle ends 116 are connected at an angle of approximately 45 degrees relative to the axis of first shaft end 112. The connection of the first handle ends 116 to the first shaft end 112 is such that the shaft cavity 634 of the shaft 104 is in fluid communication with the handle cavities 636 of the handles 106 such that when the shaft cavity 634 and/or the handle cavities 636 are filled with fluid, that fluid will flow freely from the handle cavities 636 into the shaft cavity 634 or vice versa. Although four handles are depicted, alternate embodiments of the present invention are envisioned in which the handles are omitted (i.e., a user holds the apparatus by gripping shaft 104) or a varying quantity of handles are substituted. Also, although the four handles are equidistantly spaced at the 0, 90, 180 and 270 degree positions in relation to the axis of the shaft 104, alternate spacing may be substituted without departing from the scope of the present invention.

In some embodiments of the present invention, the second shaft end 114 is coupled to the second handle ends 118. In the depicted embodiment of the present invention, there are four second handle ends 118a-118d connected to the second shaft end 114 at the approximate 0, 90, 180 and 270 degree positions in approximately perpendicular relation to the axis of the shaft 104 near the second shaft end 114. The connection of the second handle ends 118 to the second shaft end 114 is such that the shaft cavity 634 of the shaft 104 is in fluid communication with the handle cavities 636 of the handles 106 such that when the shaft cavity 634 and/or handle cavities 636 are filled with fluid, that fluid will flow freely from the handle cavities 636 into the shaft cavity 634 or vice versa. Although four handles are depicted, alternate embodiments of the present invention are envisioned in which the handles are omitted (i.e., a user holds the apparatus by gripping shaft 104) or a varying quantity of handles are substituted. Also, although the four handles are equidistantly spaced at the 0, 90, 180 and 270 degree positions in relation to the axis of the shaft 104, alternate spacing may be substituted without departing from the scope of the present invention.

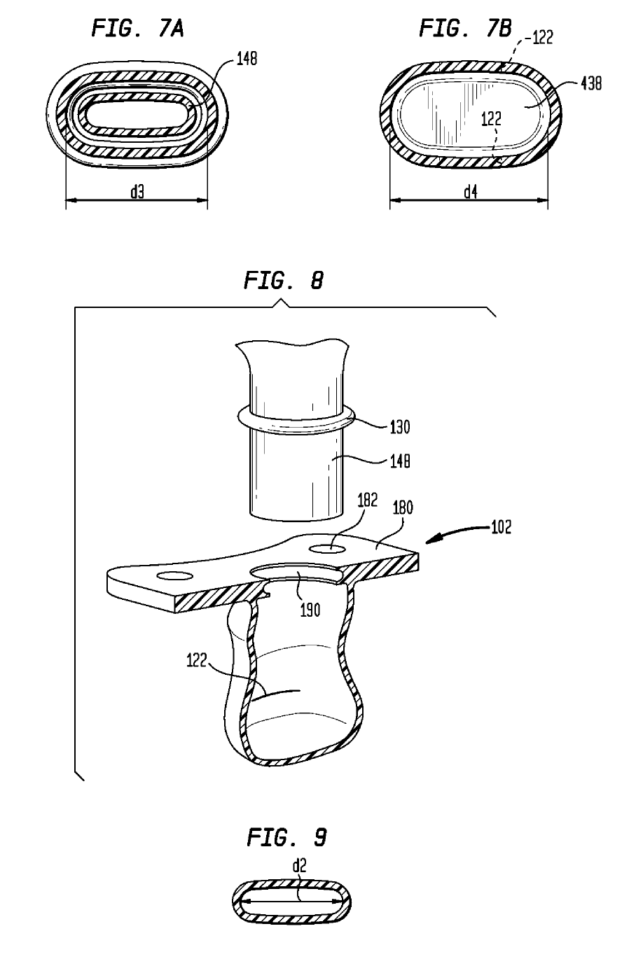

In the depicted embodiment of the invention, the diameter of each of the handles 106 decreases as the handle 106 extends from the second handle end 118 to the first handle end 116, as depicted in FIGS. 1A, 1B, and 6. Consequently, the diameter of the handle cavity 636 likewise decreases as handle 106 extends from the second handle end 118 to the first handle end 116. Preferably, the decrease in the diameter of each handle cavity 636 (FIG. 6) is gradual and uniform to provide a smooth interior surface for the handle cavity 636 (FIG. 7). The uniform decrease in the diameter of the handle cavity 636 minimizes the size of any pieces of ice or slush that may enter shaft cavity 634 as the frozen liquid within the handle cavity 636 melts since large ice or slush pieces can potentially block the shaft cavity 634, thereby preventing or hindering the passage of ice and/or slush from shaft cavity 634 into nipple 102. This blockage may prove undesirable to a user with a short attention span if such blockage prevents passage of slush and/or ice into nipple 102 such that it may be sucked, or otherwise imbibed, through aperture 122 of nipple 102. However, alternate embodiments of the present invention having handles 106 having handle cavities 636 with uniform diameters are also envisioned.

In some alternate embodiments of the present invention, the connection of first handle ends 116 to shaft 104 is staggered relative to the axis of shaft 104. That is, each first handle end 116 is connected to shaft 104 at a different longitudinal point of the axis of shaft 104. This staggering prevents or minimizes slush and/or ice jams that may occur as a frozen fluid contained within teething apparatus 100 begins to melt, thereby causing the slush and/or ice to slide down the handles 106 toward first handle ends 116 due to gravitational forces. If more than one first handle end 116 of a plurality of handles 106 is located at the same longitudinal point relative to the axis of shaft 104, such slush and/or ice from the plurality of handles 106 may collide as it enters shaft 104, thereby forming a nearly solid mass of slush and/or ice. Such a solid mass may then act to prevent or hinder the passage of ice and/or slush from shaft cavity 634 into nipple 102. This blockage may prove undesirable to a user with a short attention span if such blockage prevents passage of slush and/or ice into nipple 102 such that it may be sucked, or otherwise imbibed, through aperture 122 of nipple 102. However, alternate embodiments of the present invention having non-staggered first handle ends 116 (such as that depicted in FIGS. 1A-9) are also envisioned. Some such embodiments may include valves or other components to prevent or minimize the potential of an ice and/or slush jam. Additionally, such handles may include handles having decreasing diameters designed to prevent or minimize the potential of an ice and/or slush jam as discussed in greater detail above.

In a further embodiment of the invention, the handles 106 include an exterior surface feature 110 at the approximate midpoint of the handles 106. The exterior features 110 are roughened, or raised portions located on the surface of the handle 106. As illustrated in FIGS. 1A and 1B, the exterior features 110 can include, for example, a matrix of cubic protrusions 110a encircling the handle 106, a plurality of attached rings 110b encircling the handle 106, a matrix of hemispherical protrusions 110c encircling the handle 106, or a matrix of tetrahedron protrusions with outwardly oriented apexes 110d encircling the handle 106. Other embodiments of the exterior features 110 are contemplated, which provide similar function, without departing from the scope of the present invention. Furthermore, exterior features 110 may be omitted, or the quantity of exterior features 110 may be varied, without departing from the scope of the present invention. Also, exterior features 110 may be made from the same material, or a different material, than that of handles 106 without departing from the scope of the present invention.

The exterior features 110 provide an additional teething surface a young child may bite on, as well as enhanced gripping of the handles 106 by the young child. The location of the exterior features 110 at approximately the midpoint of the handles 106 facilitates access to such features for teething thereupon by the young child. The exterior features 110 are positioned at the outward extremes of the teething apparatus 100, as clearly shown in the top and bottom views of the teething apparatus 100 in FIGS. 2 and 3. However, alternate locations of exterior features 110 may be substituted without departing from the scope of the present invention.

The shaft and handle cavities 634 (FIG. 6) and 636 (FIG. 6), respectively, are in fluid communication with the nipple cavity 438 (FIGS. 4 and 5) via the shaft extension cavity 650 (FIG. 6), which allows the fluid to flow freely from the shaft and/or handle cavities 634 (FIG. 6) and 636 (FIG. 6), respectively, through the shaft extension cavity 650 into the nipple cavity 438 (FIGS. 4 and 5). In one embodiment, the distal end 150 of the shaft extension 148 is completely open to allow maximum flow of fluid from shaft cavity 634 and/or handle cavities 636 to the nipple cavity 438 (FIGS. 4 and 5) by passage through shaft extension cavity 650. However, alternate embodiments of the present invention are envisioned in which the distal end 150 of the shaft extension 148 is essentially closed, but includes one or more apertures for passage of fluid, slush, and/or ice from shaft extension cavity 650 into nipple cavity 438 (FIGS. 4 and 5).

In alternate embodiments of the invention, the shaft extension 148 of the teething apparatus 100 that slides into the nipple 102 may be of varying length so as to extend into the nipple cavity 438 (FIGS. 4 and 5) to varying degrees. The shaft extension 148 may extend into the nipple cavity 438 (FIGS. 4 and 5) only sufficiently to provide attachment of the nipple 102 thereto, or the shaft extension 148 may extend near the distal end of the nipple 102. One advantage of the extension of the shaft extension 148 to near the distal end of the nipple 102 is to provide additional teething/biting resistance, beyond the resistance provided by only by the material of the nipple 102. The additional resistance is desirable in that it assists the child's emerging teeth break through the gums. As mentioned above, the distal end of shaft extension 148 may be open-ended to allow maximum flow of the liquid and/or frozen solids from the shaft cavity 634 to nipple cavity 438 (FIGS. 4 and 5), or it may be essentially closed with slits or apertures therein to allow a lesser quantity of fluid, slush, and/or ice to pass from shaft cavity 634 to nipple cavity 438 (FIGS. 4 and 5).

As also depicted in FIGS. 1A-5 and 8, the nipple 102 includes a stop flange 180 at its proximal end to limit insertion of the nipple 102 into the mouth of a young child. The stop flange 180 additionally provides an easily grasped portion of the nipple 102 to assist with insertion of the shaft extension 148 into the nipple cavity 438 (FIGS. 4 and 5), as well as removing the nipple 102 from the shaft extension 148. In some embodiments of the present invention, stop flange 180 includes one or more stop flange apertures 182, which allow passage of saliva therethrough during use of teething apparatus 100. However, alternate embodiments of the present invention are envisioned in which stop flange 180 and/or stop flange apertures 182 are omitted.

Referring now to FIGS. 2 and 6, the shaft extension 148 may also include an exterior, integrated ring seal 130 that encircles the perimeter of the shaft extension 148. The ring seal 130 on the shaft extension 148 seats in a groove 190 in the interior surface of the stop flange 180 (FIG. 8), when the shaft extension 148 is inserted therein. The ring seal 130 provides a substantially watertight seal between the shaft extension 148 and the nipple 102, while allowing detachment of the nipple 102 from the shaft extension 148. This detachment facilitates cleaning of the teething apparatus 100. Further, this detachment allows the teething apparatus 100 to be used with a variety of nipples 102, which allows the nipple 102 of the teething apparatus 100 to be customized to the likes, age, and/or size of a particular user. Additionally, although the attachment of nipple 102 to shaft extension 148 is described herein with specificity via ring seal 130 and groove 190, alternate methods and/or apparatus for attachment of same may be substituted without departing from the scope of the present invention.

As depicted in the cross-sectional views of FIGS. 4 and 5, nipple 102 includes proximal and distal nipple sections 402 and 404, respectively. As best seen in the cross-sectional views of FIGS. 7A and 7B, proximal and distal nipple sections 402 and 404, respectively, have ovate cross sections having inner diameters d₃ and d₄, respectively. As seen in FIGS. 4, 7A, and 7B, inner diameter d₃ is less than inner diameter d₄. The difference between these diameters allows a user of teething apparatus 100 to hold nipple 102 internal to his or her mouth by inserting distal nipple section 404 into the mouth to a location beyond the teeth and/or gums and at least partially closing his or her mouth around nipple 102. The larger width of distal nipple section 404, as compared to the width of proximal nipple section 402, prevents, or minimizes, slippage of nipple 102 from the user's mouth. However, alternate forms of nipple 102 may be substituted without departing from the scope of the present invention. The ease of attachment and removal of nipple 102 to the shaft extension 148 accommodates use of a variety of nipples 102 with teething apparatus 100. Varying forms and/or sizes of nipples 102 may be substituted to accommodate the preferences, age, size, etc. of the user.

Similarly, as depicted in FIG. 5, the depth of proximal and distal nipple sections 402 and 404, respectively, have diameters d₅ and d₆. As seen in FIG. 5, inner diameter d₅ is less than inner diameter d₆. The difference between these diameters allows a user of teething apparatus 100 to hold nipple 102 internal to his or her mouth by inserting distal nipple section 404 into the mouth to a location beyond the teeth and/or gums and at least partially closing his or her mouth around nipple 102. The larger depth of distal nipple section 404, as compared to the depth of proximal nipple section 402, prevents, or minimizes, slippage of nipple 102 from the user's mouth. However, again, alternate forms of nipple 102 may be substituted without departing from the scope of the present invention. The ease of attachment and removal of nipple 102 to the shaft extension 148 accommodates use of a variety of nipples 102 with teething apparatus 100. Varying forms and/or sizes of nipples 102 may be substituted to accommodate the preferences, age, size, etc. of the user.

As also depicted in the cross-sectional views of FIGS. 4 and 5, nipple 102 includes a pair of apertures 122. In the depicted embodiment, each aperture 122 is in the form of a slit located at the approximate horizontal and vertical midpoints of the front and back of distal nipple section 404. Aperture 122 allows fluid, slush, and/or ice present in nipple cavity 438 to pass therethrough to the mouth of a user. The slit configuration prevents or minimizes the potential for leakage of fluid, slush, and/or ice from the teething apparatus 100 when it is not in use and/or when the temperature of the contained fluid is being altered. Although the depicted embodiment includes two apertures, a varying quantity of apertures may be substituted without departing from the scope of the present invention. Additionally, although the depicted apertures 122 are in the form of slits, varying configurations including, but not limited to, spherical, hemispherical, and ovate apertures may be substituted without departing from the scope of the present invention.

Construction of the above described embodiment of the teething apparatus 100 without the nipple 102 is preferably achieved first by fabrication of essentially mirror image halves of the apparatus and then joining the mirror image halves together. Preferably, the mirror image halves of the teething apparatus 100 are defined by a plane bisecting the shaft 104 and the pair of opposed handles 106. The tethered cap 108 is, of course, attached to only one of the halves of the apparatus. Each of the halves of the teething apparatus 100 includes a portion of the support base 126 containing two supports 124, such that joining the halves produces a total of four supports 124 oriented in an approximately rectangular configuration. The four supports 124 function as a foundation to support the invented teething apparatus, as described above. A plan view of the surface of one of the halves to be jointed to fabricate the apparatus is represented in FIG. 6. Thus, essentially all of the cavities, apertures and bores, for the above described embodiment of the teething apparatus 100, are formed upon joining of the two mirror image halves. Consequently, the fabrication of the above described teething apparatus 100 is simplified and more economical. However, alternate methods of manufacturing may be substituted without departing from the scope of the present invention.

The teething apparatus 100 without the nipple 102, including the shaft 104, the handles 106, the cap 108 and the shaft extension 148, may be constructed of various materials, including, but not limited to: silicone (flexible to semi-rigid), latex, polyurethane, or other flexible, semi-rigid, or rigid plastic or rubber-type material. In some embodiments of the present invention, at least the shaft extension 148 may be fabricated of a material that is more rigid than the nipple 102 to make it easier to push, slide, or otherwise connect the nipple 102 to the shaft extension 148.

Methods of delivering a heated, cooled, frozen, and/or partially-frozen liquid to a user's teeth, gums, mouth, and/or throat are also envisioned. One such method includes the steps of filling an apparatus such as that disclosed herein with a fluid. The fluid may be heated, cooled, frozen, and/or partially frozen prior to or subsequent to placing the liquid into the apparatus. Thereafter, the user sucks, chews, squeezes, twists, or otherwise manipulates the nipple and/or the body of the apparatus, thereby creating forces that cause one or more apertures to at least partially open such that the liquid, slush, and/or ice contained in the apparatus may pass therethrough. For example, a user may cause the liquid, slush, and/or ice to pass through the aperture via squeezing, sucking, suckling, biting, and/or chewing on the body of the nipple. Alternatively, a user may squeeze the body of the apparatus, thereby pressurizing the liquid, slush, and/or ice contained therein and forcing same through one or more apertures. Once the liquid, slush, and/or ice passes through the aperture(s), such material is located external to the apparatus at which point it may pass into the mouth of the user and contact the teeth, gums, mouth, and/or throat of the user. Such passage may occur at least in part due to the gargling, suckling, swallowing, or other similar action of the user.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of soothing teething comprising the steps of:
filling an apparatus with a fluid, said apparatus including:
a nipple, said nipple including at least one nipple cavity; and
a shaft, said shaft including at least one shaft cavity, said shaft cavity in fluid communication with the nipple cavity.
altering a temperature of said fluid contained in said apparatus; and
imbibing said fluid through said nipple of said apparatus.
